(19) United States
(12) Patent Application Publication
(10) Pub. No.: US 2015/0086952 A1
(43) Pub. Date: Mar. 26, 2015

(54) DEVICE AND METHOD FOR SUPPORTING A BEHAVIOR CHANGE OF A PERSON

(71) Applicant: KONINKLIJKE PHILIPS N.V., EINDHOVEN (NL)

(72) Inventors: Tsevetomira Kirova Tsoneva, Eindhoven (NL); Gary Nelson Garcia Molina, Madison, WI (US); Marieke Van Dooren, Arendonik (BE)

(21) Appl. No.: 14/396,244

(22) PCT Filed: May 3, 2013
(86) PCT No.: PCT/IB2013/053541

§ 371 Date: Oct. 22, 2014

Related U.S. Application Data
(60) Provisional application No. 61/644,486, filed on May 9, 2012.

(51) Int. Cl. G09B 19/00

(52) U.S. Cl. CPC G09B 19/00; G09B 19/0092
USPC 434/236

(57) ABSTRACT

The present invention relates to healthy lifestyle management. In particular to a device for supporting a behavior change of a person (11), comprising a presentation unit (4) for presenting the person with a first stimulus (5) associated with a predetermined behavior and a second stimulus (6) having positive or negative affect, an obtainment unit (2) for obtaining a characteristic feature of a first stimulus and for obtaining a characteristic feature of a second stimulus, and a selection unit (3) for selecting the first stimulus and the second stimulus to be presented based on a common feature of said first stimulus and said second stimulus. A further aspect of the invention relates to a method for supporting a behavior change of a person and a computer program for carrying out said method.

### FIELD OF THE INVENTION

The present invention relates to a device, method and computer program for supporting a behavior change of a person.

### BACKGROUND OF THE INVENTION

Healthy nutrition and regular exercise are cornerstones in healthy lifestyle management. Although people are aware of this fact, they consume unhealthy food or do not exercise regularly. Hence, there is a need for changing a person's behavior towards healthier living.

The underlying principles of the present invention are priming and affective conditioning. Priming can be understood as a non-conscious influence of past experience on current behavior or performance. The possibility of influencing behavior through priming is attractive for lifestyle management because it can be used to motivate people to adopt a healthier lifestyle. The effect of priming for a behavior change can be enhanced if such a behavior is first associated with positive affect. The motivation of people to engage in the behavior is higher if the desired behavior is associated with positive messages or also if the desired behavior has a positive connotation. Creating the association with positive affect is referred to as affective conditioning. A positive connotation can be built through affective conditioning. From a neuroscientific point of view, it is suggested that through connections with the dopaminergic system, primed behavioral states associated with positive affect excite cortical brain structures that modulate the effort that will be invested in executing such behaviors. Once the affective conditioning phase is completed, a priming phase with messages or behavioral stimuli leads to the execution of the desired behavior or more precisely increases the likelihood for the person to execute the desired behavior.

U.S. Pat. No. 8,052,425 B2 discloses an implicit attitude trainer for stimulating a user to develop or alter their implicit attitudes towards a predetermined behavior such as dieting or exercising. The user is presented with a series of stimuli on a computer screen, wherein each stimulus is associated with a behavioral object. For example the picture of an apple is associated with healthy eating, whereas the picture of a cupcake is associated with unhealthy eating. The disclosed method prompts the user to categorize each stimulus by actively moving the stimulus to either a first or a second designated zone. The first zone is associated with positive behavior, whereas the second zone is associated with negative behavior. Thus, the user consciously categorizes each item into good and bad. Correct answers are rewarded with points. This is intended to modify the behavior of the user towards items with positive connotation. The first and second zone can be personalized for example with a picture of the user in the first zone to strengthen the link between a positive behavioral stimulus and the person.

### SUMMARY OF THE INVENTION

It is an object of the present invention to provide a device and method for supporting a behavior change of a person in order to accomplish the goal of healthy lifestyle management. Moreover the device and method according to the present invention should provide a more flexible design and increased effectiveness in supporting a behavior change of a person.

In a first aspect of the present invention, a device for supporting a behavior change of a person is presented that comprises a presentation unit for presenting the person with a first stimulus associated with a predetermined behavior and a second stimulus having positive or negative affect, an obtainment unit for obtaining a characteristic feature of a first stimulus and for obtaining a characteristic feature of a second stimulus and a selection unit for selecting the first stimulus and the second stimulus to be presented based on a common feature of said first stimulus and said second stimulus.

In a further aspect of the present invention a method for supporting a behavior change of a person is presented that comprises the steps of obtaining a characteristic feature of a first stimulus associated with a predetermined behavior, obtaining a characteristic feature of a second stimulus having positive or negative affect, selecting a first stimulus and a second stimulus based on a common feature of said first stimulus and said second stimulus and presenting the person with said first stimulus and said second stimulus.

In yet another aspect of the present invention there is provided a computer program which comprises program code means for causing a computer to carry out the steps of the method for supporting a behavior change of a person according to the present invention when said computer program is carried out on the computer.

Preferred embodiments of the invention are defined in the dependent claims. It shall be understood that the claimed method and computer program have similar and/or identical preferred embodiments as the claimed device and as defined in the dependent claims.

The predetermined behavior is a desired behavior or feeling that is predetermined by the person himself or alternatively by another person such as medical personnel. Examples for desired behaviors include maintaining a healthy diet, loosing weight, exercising, calming down to a relaxed state or following a better sleep hygiene. The device presents the user with a first stimulus that is linked with the predetermined behavior and a second stimulus having positive or negative affect. The two stimuli are linked by a characteristic feature that is common to both stimuli. Thereby the user does not have to actively categorize said first stimulus but is presented by the system with both first stimulus and second stimulus. The selection unit selects these two stimuli based on the common feature of said first stimulus and said second stimulus.

This way, the present invention solves a drawback of the method known from U.S. Pat. No. 8,052,425 B2 which requires an active physical act of the user of categorizing behavioral stimuli into good and bad by moving the respective items into designated zones associated with positive or negative behavior. This approach according to prior art poses severe limitations on the design flexibility. Furthermore, the categorization task is a rather monotonous learning experience.

The system known from U.S. Pat. No. 8,052,425 B2 shows only a stimulus associated with a predetermined behavior, e.g. the picture of an apple which represents healthy eating. After each correct answer, the person is rewarded with points to create a positive association with the behavior associated with said stimulus. These points provide a certain motivation, for example when trying to reach a high score. However this motivation wears off quickly. The device according to the present invention therefore proposes using affective stimuli, in particular stimuli with emotional value.

Affective conditioning in general can be understood as a transfer of our feelings from one set of items or stimuli to another. In addition to presenting the person with a first behavioral stimulus, the present invention presents the user with a second stimulus associated with positive or negative affect. As an example for a first behavioral stimulus, the user is presented with a picture of a green apple associated with the target behavior “healthy eating”. In this example, the second stimulus for creating positive affect is a picture of a loved person or pet playing in the garden. Both stimuli share a common feature, e.g. green as the dominant color. This feature is obtained for both stimuli by the obtainment unit of the device according to the present invention. Based on these features the selection unit selects two stimuli with matching features and the presentation unit presents them to the person. In a preferred embodiment, stimuli with strong emotional value are selected. This increases the effectiveness of the affective conditioning.

Another problem of systems known from U.S. Pat. No. 8,052,425 B2 is that the person must perform a conscious categorization. Hence, the person may be well aware of being manipulated towards a predetermined desired behavior. This “priming awareness” reduces the effectiveness of affective conditioning and priming.

The present invention has identified that a subtle presentation of messages associated with behavior and affect is more effective because the user does not get aware of the affective conditioning. In other words, a categorization task according to prior art requires a rational decision into good and bad. The device according to the present invention however presents the person with two stimuli, e.g. desired behavior and positive message that are linked by a feature or low-level feature which can be perceived in a subtle way or even subconsciously and establish a positive emotional attitude towards the predetermined, desired behavior. In other words, even though the present invention can optionally comprise a physical act, a categorization is not evident and the user stays naive about the purpose, i.e. being primed. The use of subtle or subliminally presented messages for affective conditioning and to prime a target behavior intrinsically motivate the user to engage in the target behavior. Intrinsic motivation is more effective in initiating and maintaining a behavior. This kind of motivation is driven by an interest or enjoyment of the task itself, and exists within the individual rather than relying on any external pressure. Hence, the device according to the present invention increases the effectiveness of supporting a behavior change of a person.

According to another aspect of the present invention, the presentation unit is adapted to present the first stimulus and the second stimulus simultaneously. Hence, the first stimulus associated with the predetermined behavior and a second stimulus having positive or negative affect can be perceived by the person in parallel. As the link between the two stimuli is established by a common feature, they can be presented in parallel without further action of the person. Hence, the system is not limited to a first correct decision followed by a reward afterwards. This increases the flexibility of presenting said stimuli to the user.

According to another aspect of the present invention, the presentation unit is adapted to present the first stimulus and the second stimulus in short succession. The user is still under the impression of the first stimulus when the second stimulus is presented.

In an embodiment of the device according to the present invention, the presentation unit is adapted to present a plurality of first stimuli and second stimuli. This enhances the effect as the person is exposed to said stimuli over a longer period of time. Furthermore, the presentation of different stimuli prevents habituation. Alternatively, a plurality of first and second stimuli is presented simultaneously. In an embodiment one first and one second stimulus comprise a pair of stimuli that is linked by a common feature. Multiple pairs can be presented to the user sequentially or in parallel. In another embodiment one first and multiple second stimuli are presented that are linked by a common feature. In general the numbers of first stimuli and second stimuli presented to the person can be different or equal.

In a further embodiment of the device according to the present invention, the presentation unit is adapted to present stimuli of at least one modality of a group of modalities including words, images, video, audio, fragrances or haptic stimuli. This also includes the presentation of a multi-sensory stimulus for example a combination of audio and olfactory stimuli or images and words.

According to another aspect of the present invention, the obtainment unit further comprises a feature extraction unit for extracting a characteristic feature of a stimulus. Technical means for feature extraction may include a digital signal processor and memory. Feature extraction may occur on the fly e.g. in a handheld device. Alternatively a feature is extracted in advance e.g. on a computer system before the stimulus is presented to the person.

In a preferred embodiment the feature extraction unit is adapted to evaluate a low-level feature of said stimulus, such as a color or color distribution of a visual stimulus, a texture of a visual stimulus, similar letters or pronunciation, a shape of a visual stimulus, a composition of a fragrance, a rhythm of an audible stimulus, or a texture of a haptic stimulus. In particular, images can be analyzed for a dominant color, brightness, contrast, color temperature, an object, edges or spectrogram. Videos, as a combination of visual and audible stimulus, can be analyzed for same or similar images on a frame, shot or whole video level, and also with respect to camera perspective or dynamic features such as motion, tempo and the like. Textual stimuli may share same first letters, same or similar start and end, length, same parts of speech or a similar pronunciation. Audio stimuli can be analyzed in terms of volume, pitch, percussiveness statistics, tonality features, rhythmic features or prosodic features. Strength, type and composition of a fragrance may be evaluated as well as strength, frequency and dynamics of a haptic feature. It is to be understood that the present invention is not limited to the aforementioned examples but can be employed for any suitable stimulus and features thereof.

In a different embodiment of the device according to the present invention, the presentation unit is adapted to present a personalized first or second stimulus related to the person. Types of personalization include the modality of the stimulus, the content or the manner of presentation such that the stimulus has most effect on the person. For example one person reacts more strongly on audible stimuli, whereas another person may react more strongly on visual stimuli or a combination of audible stimulus and olfactory stimulus. The content of the first stimulus associated with the predetermined behavior can for example be a picture of a person running on the beach, whereas another person may react more strongly on a person running in the forest. The second stimulus having positive or negative affect may for example be selected from private pictures, audio, video or a scent related to a family member. Of course, it is possible to use another stimulus that is known to evoke a positive response in the person. For example, one person may like animal pictures whereas another person reacts more strongly on race cars or flowers. Stimuli of emotional value to the person are a preferred choice. The manner of presentation can account for the person's environment and schedule. Preferably, a kind of stimulus is used that shows best effect for the user. Further, the device can be equipped with a sensor, memory and an evaluation unit to assess the effectiveness of a certain type or combination of stimuli.

The device according to the present invention may further comprise an interface for communication with an external database. The features to be presented can easily be stored on the device itself or can be provided by an external database. The database can further comprise features associated with said first and/or second stimuli. In one embodiment the device obtains both stimuli and features extracted from said stimuli from an external database. In another embodiment said database is configured to provide only the stimuli or the features. It is to be understood that stimulus in this context also includes data relating to said stimulus which can be used to generate the stimulus with the device according to the present invention. A first stimulus, representing a desired target behavior, can be selected from a database that comprises for example pictures associated with said target behavior such as a sports database. One option for obtaining a second stimulus are public databases such as the International Affective Picture System. A second option for obtaining second or affective stimulus is accessing personalized data such as content from a social network, personal files or using machine learning algorithms. Alternatively at least some stimuli are stored on the device. The connection to said database can be wired or wireless.

In yet another embodiment of the present invention, the presentation unit is adapted to present the first stimulus and the second stimulus in form of a game. A game or game-like activity is a preferred embodiment for presenting the user with said first and second stimuli. The present invention can be employed in any setting where the person can be presented with a first and second stimulus. Hence, the device, method and computer program according to the present invention provide great flexibility in system design.

In a further embodiment of the present invention, the presentation unit is adapted to present the first stimulus and/or the second stimulus as subliminal messages. Subliminal messages are not consciously detectable by the user. Such an association can be built by presenting the behavioral stimulus and/or affective stimulus for a short duration below the perception threshold of the user.

In another aspect of the present invention, the presentation unit is adapted to further present the person with a neutral stimulus. Neutral stimuli are stimuli that are initially of neutral value, i.e. not associated with a predetermined behavior or affect. In this case, the stimulus is initially of neutral value and during the association phase not only the positive connotation but also the behavioral association with the stimulus is established. Later on, this neutral stimulus can be used as a behavioral stimulus for priming the person because the person has already learned to associate said neutral stimulus with a behavior.

According to another embodiment of the present invention, the presentation unit is adapted to further present a person with the first stimulus only. In a first step, during the affective conditioning phase, the person is presented with a first stimulus associated with a predetermined behavior and a second stimulus having positive or negative affect. Afterwards, during priming phase, the user can be primed for engaging in said predetermined behavior by using just the first stimulus. The use of the affective stimulus is then optional but can still be used to maintain and/or strengthen the affective conditioning. It should be noted that the person is also primed for the desired behavior during affective conditioning phase.

In a further embodiment of the present invention, the presentation unit is adapted to manipulate said first and/or second stimulus regarding said common feature. For example, even though the common feature is green as the dominant color, a first behavioral and a second affective stimulus could be of a different color shade or brightness. To strengthen the link between behavioral and affective stimulus, the presentation unit can alter the color of at least one of said stimuli for a better match between behavioral and affective stimulus. In a further example, the tempo or pitch of audible stimuli can be assimilated.

### BRIEF DESCRIPTION OF THE DRAWINGS

These and other aspects of the invention will be apparent from and elucidated with reference to the embodiment(s) described hereinafter. In the following drawings

FIG. 1 shows a block diagram of the device for supporting a behavior change of a person according to the present invention;

FIG. 2 illustrates the relation between behavioral stimulus, affective stimulus and the person;

FIG. 3 shows an application scenario using the device according to the present invention for affective conditioning and priming;

FIG. 4 shows a modification of the application scenario in FIG. 3;

FIG. 5 shows an example of how to present a behavioral stimulus and an affective stimulus to the person in a game-like setting; and

FIG. 6 shows a further example of how to present a behavioral stimulus and an affective stimulus to the person.

### DETAILED DESCRIPTION OF THE INVENTION

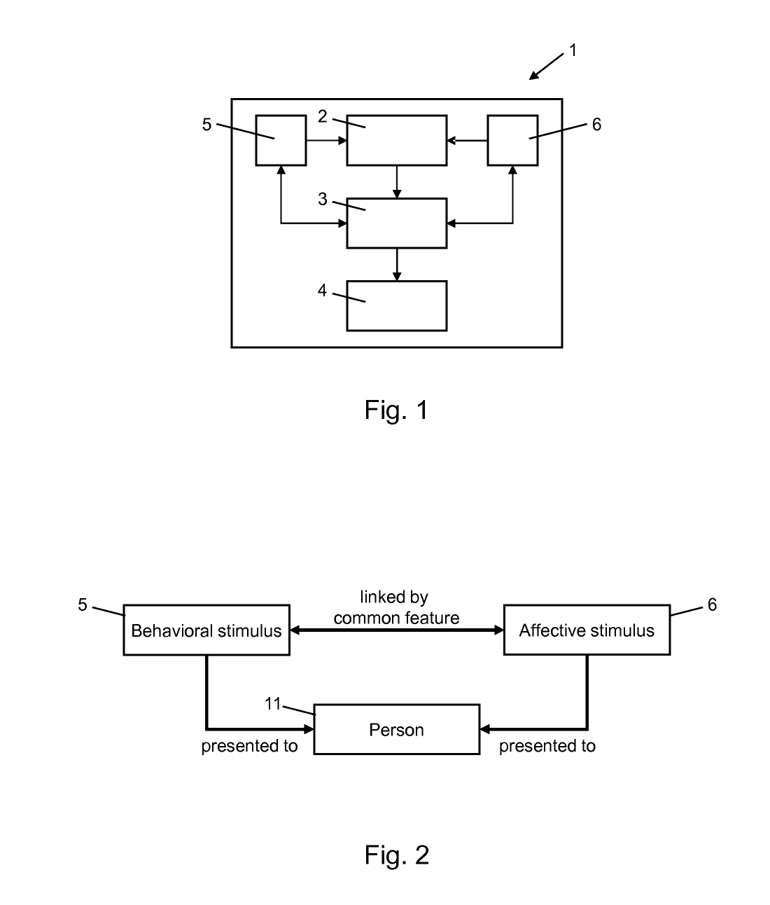

The device for supporting a behavior change of a person according to the present invention is illustrated by an example in the block diagram shown in FIG. 1. The device 1 for supporting a behavior change of a person comprises an obtainment unit 2, a selection unit 3 and a presentation unit 4. The block diagram further illustrates a first or behavioral stimulus 5 associated with a predetermined behavior and a second or affective stimulus 6 having positive or negative affect. When referring to “stimulus” this also includes information or data representative of said stimulus before being in a form ready for presentation to the person. For example an image as a visual stimulus does not only refer to the presentation of an image but also includes the image file, such as a .jpg or .bmp file, representative of said visual stimulus.

The obtainment unit 2 is configured to obtain a characteristic feature of a first stimulus 5 and to obtain a characteristic feature of a second stimulus 6. The information about characteristic features of said first stimulus 5 and said second stimulus 6 is provided by the obtainment unit 2 to the selection unit 3. The selection unit 3 is adapted to select the first stimulus 5 and the second stimulus 6 to be presented to the person. The selection is based upon a common feature of said first stimulus 5 and said second stimulus 6 that has been obtained by the obtainment unit 2. Upon selecting said first stimulus 5, data representative of said first stimulus 5 is provided to the selection unit 3. The same holds true for the selection of a second stimulus 6. Alternatively data representative of said stimulus can be provided to the selection unit 3 through the obtainment unit 2. The first stimulus 5 and second stimulus 6 are passed on from the selection unit 3 to the presentation unit 4. The presentation unit 4 is adapted to present the person with said first, behavioral stimulus 5 and said second, affective stimulus 6.

FIG. 2 shows a simplified diagram of the relation between behavioral stimulus 5, affective stimulus 6 and the person 11. The behavioral stimulus 5 is carefully selected with the intension to trigger a desired behavior of the person 11. If the desired behavior is healthy eating then the behavioral stimulus 5 could be the picture of a red apple associated with healthy eating. This behavioral stimulus 5 is then presented to the person 11. As a consequence to being presented with said behavioral stimulus 5, the person 11 is primed towards healthy eating, for example eating a red apple. Alternatively, if the desired behavior would be gaining weight, then the person 11 could be presented with the picture of a candy bar, which in turn increases the likelihood of the person 11 to feel a craving for chocolate. This effect of priming on a behavior can be enhanced if such behavior is associated with positive affect. Therefore, an affective stimulus 6 is also presented to the person 11. The affective stimulus 6 could for example be just the word healthy. Now that the person 11 sees the picture of the red apple and the word healthy he knows that this type of food is good for him. However, he may feel blatantly manipulated. Alternatively, as a more subtle type of affective stimulus 6 a picture of a smiling person could be presented alongside with the behavioral stimulus 5. The picture of a smiling person implies positive feelings and suggests that the presented red apple is good for the person 11.

The method and device according to the present invention take this idea one step further. According to the present invention behavioral stimulus 5 and affective stimulus 6 are selected such that they are linked by a common feature. In the example above with the red apple as the behavioral stimulus for healthy eating, the picture for the affective stimulus 6 could be a kid playing with a balloon. The common feature that links behavioral stimulus 5 and affective stimulus 6 in this example is the shape of the apple and the shape of the balloon. The link can be further strengthened if behavioral stimulus 5 and affective stimulus 6 share additional features, for example apple and balloon being of the same color. The impact of the affective stimulus 6 can be further strengthened, if the affective stimulus 6 has an emotional value to the person 11. In particular, a picture of a family member for example one's own kid playing with said balloon, could be selected. Alternatively any other affective stimulus 6 that the person 11 has a positive attitude to could be selected. Alternatively, if the predetermined behavior is a behavior that the person 11 should refrain from, affective stimuli 6 of negative value might be used.

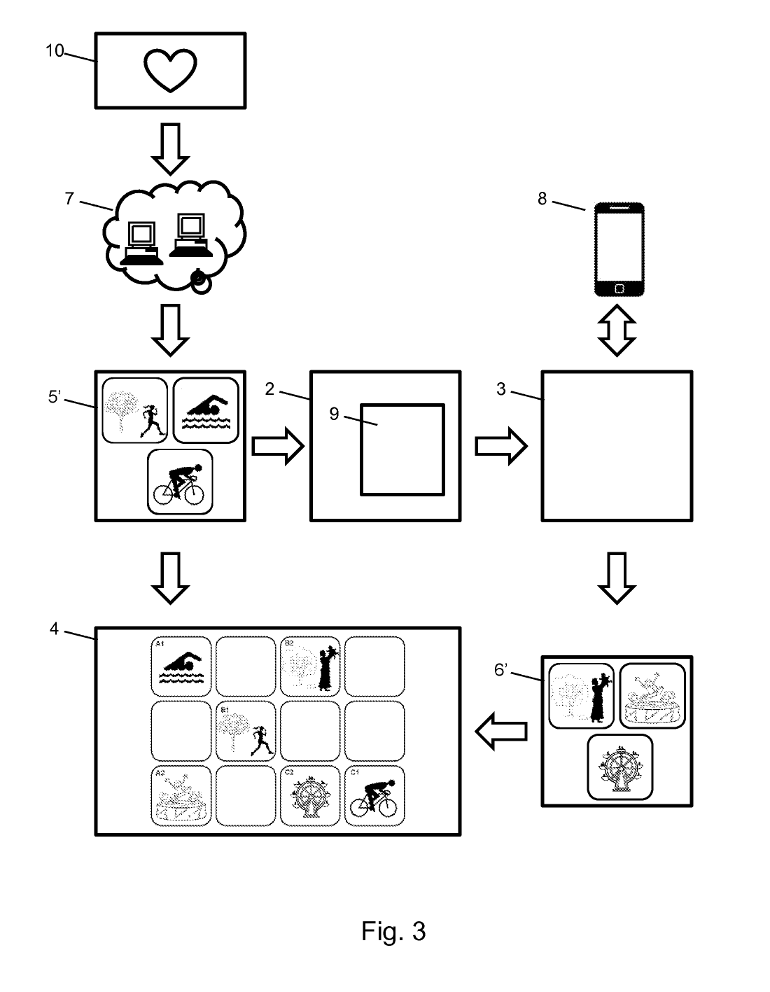

FIG. 3 shows an application scenario of the device for supporting a behavior change of a person according to the present invention for affective conditioning and priming.

The desired behavior 10 of a person is a healthy lifestyle, in particular a healthy cardiovascular system. The person himself and/or medical personnel determine how to change the behavior of a person to reach this goal. For the example of a healthy cardiovascular system, regular exercise is highly recommended. The desired predetermined behavior can be defined as regular exercise. Therefore, the first stimuli 5′ associated with the predetermined behavior can be selected accordingly.

In this embodiment said behavioral stimuli are selected from an external database 7. The selection may account for user preferences and medical necessities. The database 7 provides a set 5′ of behavioral stimuli comprising one or more behavioral stimuli 5. In this example images are used again for ease of presentation. Alternatively other modalities or stimuli such as audio, video, textural, olfactory or any other type of suitable stimuli can be used. The obtainment unit 2 is adapted to obtain characteristic features of said behavioral stimuli in the set 5′ of behavioral stimuli. The obtainment unit 2 further comprises a feature extraction unit 9 for extracting a characteristic feature of a stimulus. The information about behavioral stimuli and associated characteristic features are provided to the selection unit 3. In this embodiment the selection unit 3 has an interface for communication with an external device such as an external storage or a smart phone 8. In this example a multitude of family pictures is stored on the smart phone 8 and features of said affective stimuli are also provided to the selection unit 3 by the smart phone 8.

Based on the characteristic features of the behavioral stimuli 5 of the set 5′ of behavioral stimuli, the selection unit 3 selects affective stimuli sharing a common feature. One affective stimulus is selected for each behavioral stimulus. Alternatively different numbers of behavioral stimuli and affective stimuli can be used. The output of this selection process is a set 6′ of affective stimuli. The presentation unit 4 is adapted to present a plurality of behavioral stimuli of the set 5′ and the matching affective stimuli of the set 6′. The presentation unit is further configured to present behavioral and affective stimuli simultaneously. The presentation of said stimuli to the person can occur with or without interaction of the user. In a preferred embodiment, first and second stimuli are presented in a game-like setting.

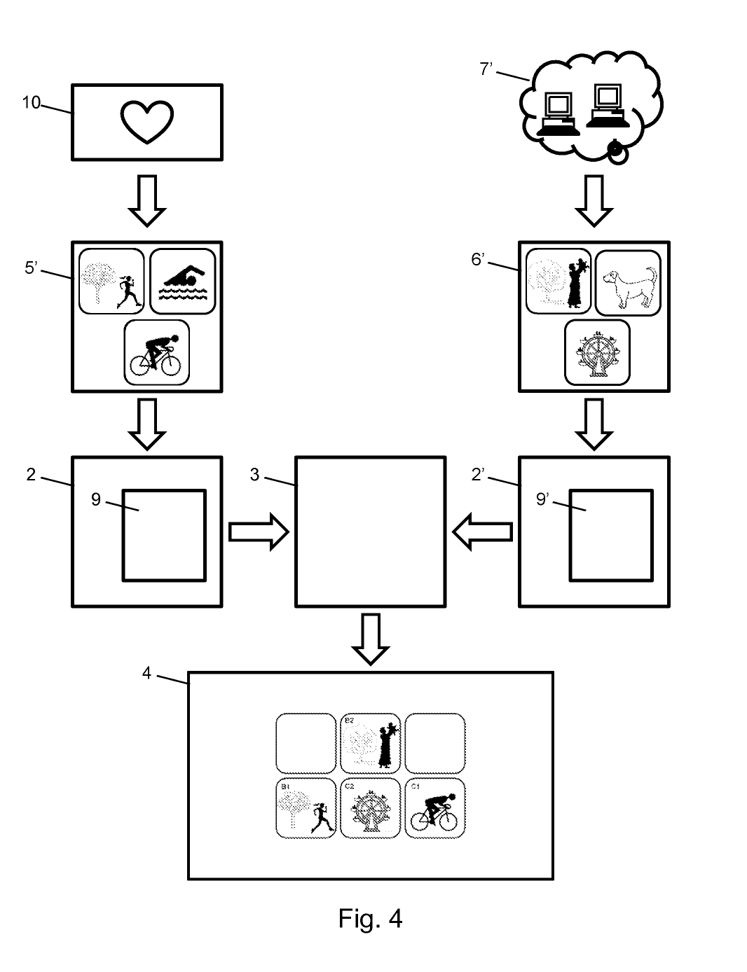

FIG. 4 shows a modification to the graph presented in FIG. 3. Only differences are highlighted. In this embodiment the set 5′ of behavioral stimuli can be directly derived from a multitude of behavioral stimuli 5 saved in a memory of the device for supporting a behavior change of a person according to the present invention. Upon choosing the desired behavior change, the device provides suitable behavioral stimuli. These behavioral stimuli are passed on to the obtainment unit 2, which further comprises a feature extraction unit 9 for extracting a characteristic feature of a stimulus. The obtainment unit 2 provides the selection unit 3 with said behavioral stimuli and respective characteristic features.

A second database 7′, for example a social network, provides a set 6′ of affective stimuli to the obtainment unit 2′. It should be noted that the obtainment unit 2 and the obtainment unit 2′ can be built as one device that is shared among behavioral stimuli and affective stimuli. The obtainment unit 2′ further comprises a feature extraction unit 9′ for extracting a characteristic feature for each affective stimulus. The affective stimuli as well as the corresponding features are provided to the selection unit 3 as well. The selection now compares the extracted features of behavioral stimuli and affective stimuli in order to find correspondences. In this example there are three behavioral stimuli and three affective stimuli. However, not all of them share common features. In this particular example, no correspondence can be found for the person swimming in the water within the set 5′ of behavioral stimuli. Accordingly there is no match for the picture of the pet in the set 6′ of affective stimuli. Therefore, the presentation unit 4 only presents the person with a plurality of behavioral stimuli and a plurality of affective stimuli for which an appropriate match could be determined based on a common feature.

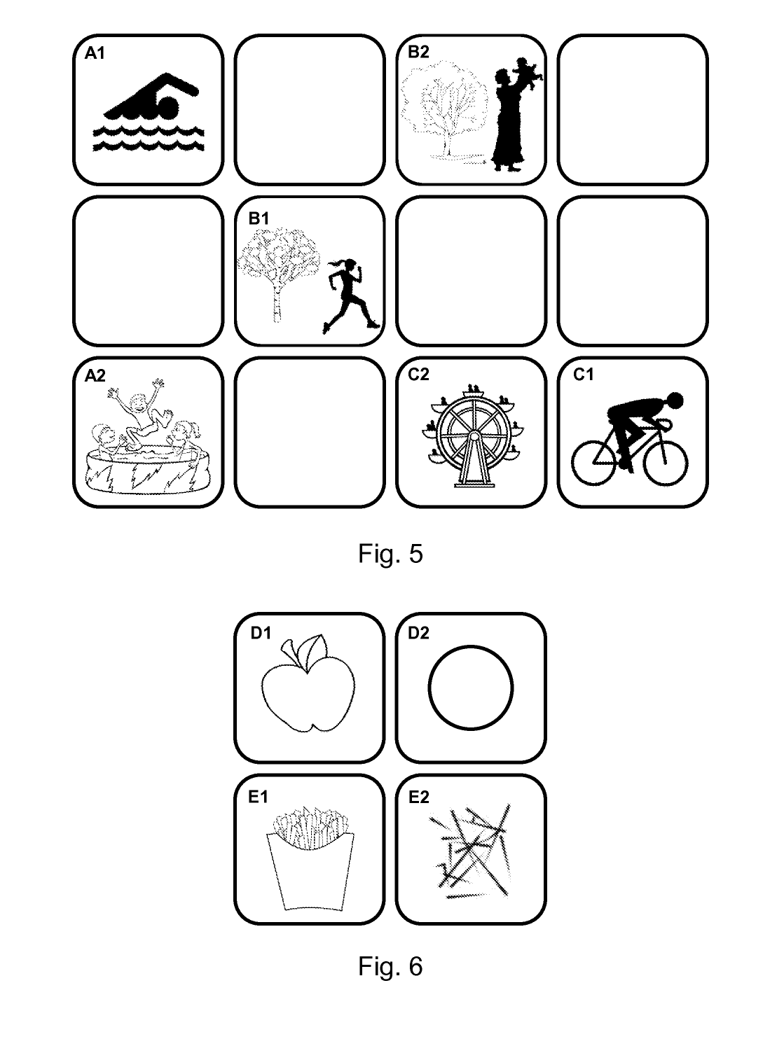

In FIG. 5, the presentation unit according to the present invention is configured to present a plurality of first stimuli and second stimuli in parallel in form of a memory association game.

In this memory game, a set of cards sharing a certain feature are flipped downwards initially. The user has to select two cards every turn and try to match the cards sharing a common feature. If the two cards sharing the feature are the same they stay face up, if not they are turned face down again. The game finishes when all cards are facing upwards.

In this example, the desired behavior, that the user should be supported in reaching, is strengthening the cardiovascular system by regular exercise. The first card A1 in the top left corner of FIG. 4 shows a person swimming the crawl, hence a behavioral stimulus motivating the person to engage in physical activity. The corresponding picture of an affective stimulus is shown in the bottom left corner by memory card A2. A2 shows family members having fun in the water. Both pictures are linked by a common feature, i.e. blue as the dominant color of water. This feature can easily be obtained from the image data of the first and second stimulus with the obtainment unit of the device according to the present invention. Further features of the stimuli can be evaluated. For example the behavioral stimulus C1 and the affective stimulus C2 share the structural element of a circle which links both pictures. Alternatively a texture can be analyzed as exemplarily depicted in behavioral stimulus B1 and affective stimulus B2. B1 shows a person running in the forest, whereas B2 shows a person with a child in front of a tree. Texture and distribution of people and elements can be analyzed. Once again, the dominant color green can be evaluated. In this case, also the color distribution with green as the dominant color in the left hand side of the picture can be taken into account.

In the example in FIG. 6, the aim is to encourage healthy eating and to discourage unhealthy eating. The user is presented simultaneously with images D1, D2, E1 and E4. Image D1 of an apple serves as a behavioral stimulus associated with healthy eating. Image E1 of fried potatoes serves as a behavioral stimulus associated with unhealthy eating. Images D1 and D2 share a smooth round shape as the common feature, while images E1 and E2 are both objects having sharp edges. In terms of affective connotation, the round-smooth edges in D2 evoke positive attitude whereas the sharp edges in E2 evoke negative attitude. In conclusion the healthy apple is associated with positive affect, while fried potatoes are associated with negative affect.

The presentation unit can be adapted to provide the person also with different game-like activities for presenting first and second stimulus for affective conditioning and priming. A further example is the game Tetris, wherein a random sequence of shapes composed of four square blocks each fall down in a plane field displayed on the presentation unit. The objective of this game is to manipulate these shapes, by moving each one sideways and rotating it by 90°, with the aim of creating a horizontal line of for example ten blocks without gaps.

In a further embodiment, the game-like embodiment is similar to the game Jewels, where the objective is to swap a gem with an adjacent gem to form a horizontal or vertical chain of three or more gems. Each gem of a set could be a behavioral or affective stimulus that shares a common feature. A chain of three gems could be composed of one behavioral stimulus and two affective stimuli or any other combination of gems that share a common feature.

In a further game-like embodiment, called Mahjong, tiles are arranged in a special four-layer pattern with their faces upwards. The goal is to match open pairs of identical tiles and to remove them from the board, exposing the tiles under them for play. The game is finished when all pairs of tiles have been removed from the board or when there are no exposed pairs remaining. Once again, pairs can be made up from behavioral and affective stimuli.

In the game Mazes, the user has to navigate in a form of complex branching passages and has to finish a route linking the start and the end point.

In a further embodiment first and second stimuli are successively revealed in a game called Puzzles. The person is intended to put together pieces in a logical way in order to come up with the desired solution. Of course, different forms of those or other games using different stimuli of different modalities can be created.

In a further embodiment, the desktop background of a computer is used as the presentation unit. Background pictures are selected from behavioral stimuli and affective stimuli such that the person is exposed to behavioral stimuli and an affective stimuli that are selected by the selection unit based on a common feature. The common feature of said first stimulus and said second stimulus that has been obtained from an obtainment unit.

In yet another embodiment, audible stimuli are employed as first and second stimuli. The desired behavior is considered to be physical exercising. Background noise of typical sounds from a gym club can for instance be matched with background noise of a song which has positive affect for the user. The choice of the song can be done automatically from the user's mobile device and according to their preferences. In addition to background noise, the pitch, tempo, etc. of behavioral stimulus and affective stimulus can be matched to establish or strengthen a link between behavioral and affective stimulus at feature level.

In a further embodiment, the desired behavior is good sleep hygiene, in particular going to bed at the same time. An olfactory behavioral stimulus that is associated with sleep is the scent of the detergent used to wash the sheets. As an affective stimulus, the user is presented with another olfactory stimulus which has positive affect. For example, the user is presented with a smell of flowers. This second olfactory stimulus is selected such that is comprises certain aromas that also form part of the scent of the detergent. This way, a feature level, subliminal link is established. Of course a multimodal stimulus can be employed that further comprises audio, images or pictures with positive affect in addition to said second olfactory stimulus.

In another embodiment, the user can be exposed to videos as a combination of audible and visual stimuli. A behavioral stimulus of a person running is followed by an affective stimulus of kids chasing each other. This supports engaging in physical activity. Alternatively a video of sports swimming could be followed by a picture or video of friends having fun in the water.

In further game-like setting, the user is presented with several songs. Some songs are considered behavioral stimuli e.g. sports related while other songs are affective stimuli that are selected from favorite songs of the person. The person now has to find how the songs are related. For example the songs share the word ‘run’ in the lyrics, a similar rhythm or melody. Alternatively, assuming that a database of personalized favorite songs is not available, happy popular melodies can be employed to generate positive affect.

As another example for supporting physical activity, the user is presented with their exercise plan as the behavioral stimulus and then, in short succession or in parallel, with a ranking table of soccer teams. Both exercise plan and ranking table share a similar layout as a common feature. The success of soccer teams is thus associated to the user's exercise plan. Thereby, the user's motivation increases and supports a behavior change. In addition, a goal scoring video can be presented to increase the emotional value and to further strengthen the effect.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims.

In the claims, the word “comprising” does not exclude other elements or steps, and the indefinite article “a” or “an” does not exclude a plurality. A single element or other unit may fulfill the functions of several items recited in the claims. The mere fact that certain measures are recited in mutually different dependent claims does not indicate that a combination of these measures cannot be used to advantage.

A computer program may be stored/distributed on a suitable medium, such as an optical storage medium or a solid-state medium supplied together with or as part of other hardware, but may also be distributed in other forms, such as via the Internet or other wired or wireless telecommunication systems.

Any reference signs in the claims should not be construed as limiting the scope.

1. Device for supporting a behavior change of a person, the device comprising obtainment unit, a selection unit, and a presentation unit,
wherein
the obtainment unit communicatively connected to a memory or a database for receiving and evaluating stimuli data representative of at least a first stimulus and a second stimulus, and wherein the obtainment unit comprises a feature extraction unit for analyzing said stimuli data for extracting a features of said first and second stimulus for obtaining a characteristic feature of a first stimulus and for obtaining a characteristic feature of a second stimulus,
wherein the selection unit is connected with said obtainment unit for receiving said stimuli data of the first stimulus and the second stimulus and feature data of the characteristic feature, wherein the selection unit is arranged for selecting based on said stimuli data and said feature data, the first stimulus and the second stimulus to be presented based on a common feature of said first stimulus and said second stimulus, and
wherein the presentation unit is connected with the selection unit for receiving the stimuli data of the selected first and second stimulus, for presenting the person with a first stimulus associated with a predetermined behavior and a second stimulus having positive or negative affect.

2. The device according to claim 1, wherein the presentation unit is adapted to present the first stimulus and the second stimulus simultaneously.

3. The device according to claim 1, wherein the presentation unit is adapted to present the first stimulus and the second stimulus in short succession.

4. The device according to claim 1, wherein the presentation unit is adapted to present a plurality of first stimuli second stimuli.

5. The device according to claim 1, wherein the presentation unit is adapted to present stimuli of at least one modality of a group of modalities including words, images, video, audio, fragrances or haptic stimuli.

6. (canceled)

7. The device according to claim 1, wherein the feature extraction unit is adapted to evaluate a low level feature of said stimulus, said low level feature including at least one of a group comprising: a color or color distribution of a visual stimulus; a texture of a visual stimulus; similar letters or pronunciation; a shape of a visual stimulus; a composition or strength of a fragrance; a rhythm of an audible stimulus; a texture, strength, frequency or dynamics of a haptic stimulus; image features, such as a dominant color, brightness, contrast, color temperature, an object, edges or spectrogram of an image; same or similar images in a frame, shot of a video, or in a whole video; video features, such as a camera perspective, motion, and tempo; audio features, such as volume, pitch, percussiveness statistics, tonality features, rhythmic, features or prosodic features.

8. The device according to claim 1, wherein the presentation unit is adapted to present a personalized first or second stimulus related to the person.

9. The device according to claim 1, further comprising an interface for communication with an external database.

10. The device according to claim 1, wherein the presentation unit is adapted to present the first stimulus and/or the second stimulus as subliminal messages.

11. The device according to claim 1, wherein the presentation unit is adapted to present the first stimulus and/or the second stimulus form of a game.

12. The device according to claim 1, wherein the presentation unit is adapted to further present the person with a neutral stimulus.

13. The device according to claim 1, wherein the presentation unit is adapted to manipulate said first and/or second stimulus regarding said common feature.

14. A method for supporting a behavior change of a person using a device comprising an obtainment unit, a selection unit, and a presentation unit, the method comprising the steps of:
receiving, by the obtainment unit, stimuli data representative of at least a first stimulus, associated with a predetermined behavior, and a second stimulus, having positive or negative affect;
analyzing said stimuli data for extracting, using a feature extraction unit comprised by the obtainment unit, features of the first stimulus, for obtaining a characteristic feature thereof;
analyzing said stimuli data for extracting, using the feature extraction unit comprised by the obtainment unit, features of the second stimulus obtaining characteristic features thereof;
the selection unit receiving said stimuli data of the first stimulus and the second stimulus and feature data of the characteristic feature;
selecting, by the selection unit, a first stimulus and a second stimulus using the stimuli data and the feature data, based on a common feature of said first stimulus and said second stimulus;
receiving, by the presentation unit, the stimuli data of the selected first and second stimulus; and
presenting, by the presentation unit, the person with said first stimulus and said second stimulus.

15. Computer program comprising program code means for causing a computer to carry out the steps of the method as claimed in claim 14 when said computer program is carried out on the computer.
